(19) United States
(12) Patent Application Publication
(10) Pub. No.: US 2007/0008279 A1
(43) Pub. Date: Jan. 11, 2007

(54) Optically triggered interactive apparatus and method of triggering said apparatus

(76) Inventors: Steven David Benford, Beeston (GB); Tony Paul Pridmore, Chesterfield (GB); Ahmed (nmi) Ghali, Beeston (GB); Jonathan Paul Green, Dunkirk (GB)

Correspondence Address: BAKER BOTTS L.L.P., 2001 ROSS AVENUE, SUITE 600, DALLAS, TX, 75201-2980, US

(21) Appl. No.: 10/540,498

(22) PCT Filed: Dec. 19, 2003
(86) PCT No.: PCT/GB03/05564

§ 371 Date: Jun. 5, 2006

(30) Foreign Application Priority Data
Dec. 23, 2002 (GB) 0229772.9

(51) Int. Cl. G09G 5/00

(52) U.S. Cl. 345/156

(57) ABSTRACT

An optically triggered interactive apparatus (100), comprises a video camera (104) arranged to capture a reference video image of a scene (112). A graphical user interface (107) is used to select a target area (124b) within the reference video image. A processor (106) arranged to detect the presence of light incident within the target area (124b) of an active video image captured by the video camera (104). The processor is arranged to determine an outer extent of an torch beam (136a,b) within the scene (112) and outputs a trigger signal to a further processor (102ah) when a given proportion of the target area forms part of the illuminated area and/or when a given proportion of the illuminated area lies within the target area.

This invention relates to an optically triggered interactive apparatus and a method of triggering said apparatus. More particularly, but not exclusively, the invention relates to an interactive apparatus that is triggered by a broad band, broad beam, directional light source and a method of triggering said apparatus.

The use of light source, for example laser pointers, to trigger sensors mounted within a scene is known. The sensors are typically used to control the output of an audio and/or visual data file. Such systems are found in museums, and tourist attractions, where an audio file is triggered and downloaded onto a handheld device in order to inform a user about their environment, or about an exhibit (the sensor being mounted near the exhibit).

Laser pointers have a problem associated with them in that due to their highly collimated nature a slight angular deflection at a laser source results in a deviation of the whole beam such that the beam falls off the sensor. The data file can stop “playback” to a user when the beam falls off the sensor, only to be restarted when the beam resides on the sensor again. This leads to a jittery, disjointed audio-visual experience for a user of the system. Alternatively, the laser beam can be used merely to trigger a data file that runs to completion when triggered accidentally or a user has experienced the audio-visual file already. Also if a succession of visitors arrive at an exhibit later visitors can arrive part way through the playback of the data file, after the person who triggered the data file's playback has moved away. It can then be irritating for the later visitors to wait for the data file to play all the way through before they can restart the data file.

Additionally, due to the coherent nature of laser light, it is not readily possible to distinguish between laser sources using sensors used to trigger audio-visual displays. This makes identifying a user and tracking their progress around an exhibit or building very difficult.

Another concern with the use of a laser source is the potential damage to eyes caused by accidental exposure to the direct laser beam. The use of laser beams may damage delicate artefacts due to the high intensity of the emitted radiation.

Infra-red activated systems are also know, in which infrared beamers (like a TV remote control) are used to point at infrared tags that are positioned on a display, several such systems exist that are targeted at museums and galleries. The problems with these are that the infra-red radiation is invisible so that a user of the system cannot see what is being pointed at, sensors have to be attached to the surface, limited scale and range, and limited resolution. It is hard to select from many targets that are close together on the surface.

The mounting of sensors within a scene can itself be problematic as sensors must be fixed to a point within a scene over which a user/visitor can point their laser. For example, the fixing of a sensor to a historic tapestry or work of art would present special problems. Mounting sensors high up, or in awkward to access areas for infra-red activated systems has it's own attendant problems.

Also, should a different area of a scene be selected as a trigger area for an infra-red activated system from the one currently used, for example if a museum's management decide to change an exhibit, it is necessary to demount a sensor, or disconnect it, and mount, or connect a new sensor in the newly selected trigger area. This can involve substantial amounts of work and labour to effect such a physical location of the sensor in the target area. This provides an inertia against changing things too often.

It is an aim of the present invention to, at least partially, ameliorate at least one of the above-mentioned problems and/or difficulties.

According to a first aspect of the present invention there is provided an optically triggered interactive apparatus, comprising scene capture means arranged to capture an image of a scene, target selection means arranged to select a target area within a reference image of a scene, detection means arranged to detect the presence of light incident within the target area of an active video image captured by the scene capture means, the detection means is arranged to determine an outer extent of an illuminated area, illuminated by a light source, within the scene, and the detection means being arranged to output a trigger signal to processing means when a given proportion of the target area forms part of the illuminated area and/or when a given proportion of the illuminated area lies within the target area.

The use of a video images of a scene with target areas selected within the scene obviates the necessity to attach sensors to the target areas of the scene. Additionally, a light beam can easily be seen by the user and others nearby who may be interacting with the apparatus at a distance. This arrangement also supports collaborative triggering. Also, a torch beam actually illuminates the scene so that the user can see it better—useful in naturally dark environments or where light levels need to be kept low, for example to protect valuable artefacts that might degrade over time.

It will be appreciated that the term optical as used herein encompasses not only visible radiation but also infra-red and ultra-violet radiation.

The light source may be any one, or more, of the following: broad band, directional, spatially extensive.

The scene capture means may comprise a video camera, a CCD device, or the like.

The illuminated area may be variable in size or it may be fixed in size, typical sizes of the illuminated area range from 1 cm² to 75 cm². The illuminated area may be as large as 1 m², and possibly as much as, or larger than, 10 m². The use of a beam of a sizeable, finite size reduces and ideally removes the effects of wobble and re-triggering, when a beam falls off a target area and back on to it, as a proportion of the beam can usually be maintained on the target area. The target area may range from 4 cm² to 400 cm², with a typical target area being approximately 100 cm² but could be as large, or larger than, as 1-10 m².

The target selection means may comprise a graphical user interface (GUI) which may be running on a computer such as, for example, a personal computer (PC). The use of a GUI allows the simple and rapid alteration, for example repositioning, resizing and/or reshaping, of target areas within a captured image without having to physically move sensors.

The detection means may comprise a signal processor. The detection means may be arranged to compare the reference image with the active image in order to detect the presence of light incident with the target area. The detection means may be arranged to track movement of at least one beam of light incident upon the scene. The detection means may be arranged to monitor either one, or both, of an intensity profile or, and, a chromatic profile of a light source, incident upon the scene. The detection means may be arranged to track a given light source, incident upon the scene based upon either, or both, of the intensity profile or, and, the chromatic profile of the light source incident upon the scene.

The detection means may be arranged to determine a centroid, or other spatial or radiometric features, of an illuminated area within the scene and may be arranged to output the signal when the feature is within a target area.

The detection means may be arranged to determine an outer extent of an illuminated area within the scene and may be arranged to output the signal when a given proportion of the target area forms part of the illuminated area and/or when a given proportion of the illuminated area lies within the target area. The outer extent of the illuminated area may be determined by a threshold intensity, or a threshold contrast between adjacent regions of the illuminated area.

The light source may be a torch. Torches have non-uniform, highly individual, intensity profiles that act as fingerprints and allow them to be identified and possibly tracked individually upon demerging of two or more merged torch beams. The light source may be focusable. The light source may be arranged to be modulated, typically in a manner that is not visible, or not readily visible, to the human eye. The detection means may be arranged to increment a counter, or any other time based measurement, each time a given light source, or light source from a group of predetermined light sources, or any light source, illuminates a given target area. The detection means may be arranged to output a trigger signal that is dependent upon the value of the counter. The actuation means may be arranged to output an audio, a visual or an audio-visual rich media file that is dependent upon the trigger signal output by the detection means. This allows a different output each time to be played to a user upon different occasions of the same light source illuminates a target area, or another particular pattern of activity, for example, when specific gestures are detected.

The scene capture means may include the detection means. The trigger signal may be transmitted wirelessly over a local area network (WLAN) to the actuation means. The actuation means may be arranged to output an audio, a visual or an audio-visual rich media file upon receiving the trigger signal.

The apparatus may comprise a plurality of image capture means, each of which may be arranged to capture an active image of the scene, viewing the scene from different viewpoints and/or angles. The detection means may be arranged to receive inputs from each of image capture means and may be arranged to output a trigger signal to the actuation means if one or more target areas is illuminated in at least one of the active images.

This arrangement with multiple video cameras, image capture means, reduces the chance that an active target area will be obscured from view of the scene capture means by a user or third party.

It will be appreciated that the scene may be a virtual scene, for example a data construct, which may be projected on to a surface. The reference image may be a map of the virtual scene. Thus, it is not necessary for the scene to be a physical scene it may be a computer generated scene or a scene stored on a data storage device which may, or may not, be projected on to a surface. The reference scene may be an empty co-ordinate framework data structure upon which the location of a target area is registered.

According to a second aspect of the present invention there is provided a method of optically triggering an interactive apparatus comprising the steps of:
i) defining at least one target area within a reference image of a scene;
ii) illuminating a portion of the scene with a light source;
iii) capturing an active image of the scene;
iv) determining a boundary of an area of illumination of the light source;
v) determining whether a predetermined fraction of the area of illumination illuminates at least part of a target area; and
vi) outputting a trigger signal if the light source illuminates at least a part of the target area on a predetermined manner.

The method may include providing the light source as any one, or more, of the following: broad band, directional, spatially extensive.

The method may include determining whether a centroid of an area of illumination of the light source is disposed within at least part of a target area. The method may include determining a boundary of an area of illumination of the light source and may further include determining whether a predetermined fraction of the area of illumination illuminates at least part of a target area.

The method may include selecting, or defining, the target area, or areas by means of a graphical user interfaces.

The method may include comparing the reference image with the active image in order to determine if a target area is at least partly illuminated. The method may include identifying a light source illuminating an area of the scene, for example by means of either an intensity profile or a chromatic profile. The method may include tracking the movement an area of illumination within the scene.

The method may include tracking the movement of a plurality of light sources illuminating areas of the scene.

The method may include incrementing a counter each time a trigger signal is generated by a selected given light source illuminating at least part of a target area, or when one of a selected group of light sources do so, or when any light source does so. The method may include outputting a differing trigger signal dependent upon the value of the counter.

The method may include outputting an audio, a visual or an audio-visual rich media file in response to a processor receiving the trigger signal.

The method may include outputting the trigger signal via a wireless local area network (WLAN) to the processor.

The method may include capturing a plurality of active images of the scene from a number of image capture means spaced thereabout.

According to a third aspect of the present invention there is provided a user interface located at a user device for use in selecting a target area and a corresponding output file for an optically activated interactive apparatus comprising:

an input mechanism for selecting an area of an image displayed upon a screen of the device as a target area;

an input mechanism for selecting the output file corresponding to the selected target area and/or another aspect of the image, the target area and output file having a link generated therebetween; and

an output mechanism arranged to output the output file upon a trigger condition being fulfilled.

The trigger condition may be an image capture means capturing an image of the target area being at least partially illuminated by a broad beam light source

According to a fourth aspect of the present invention there is provided a method of determining user demographic statistics comprising the steps of:
i) providing each user with an identifiable light source;
ii) recording demographic information about each user;
iii) providing an optically triggered interactive apparatus in accordance with the first aspect of the present invention;
iv) recording each time a target area is triggered by a user; and
v) identifying each user by correlating their identifiable light source with their demographic information.

The method may include recording how long each target area is illuminated by a users light source. The method may include storing the demographic data and the recorded data for a period of days, weeks, or months.

According to a fifth aspect of the present invention there is provided a method of defining a target area, for use with an apparatus in accordance with the first aspect of the present invention, within a scene comprising:
i) displaying a reference image upon a screen;
ii) selecting an area of a screen as a target area; and
iii) confirming the selection of the target area.

The method may include using a user manipulated device such as a keyboard, mouse, trackball or touchscreen to select the target area from the screen.

According to a sixth aspect of the present invention there is provided a method of providing exhibit commentary comprising the second aspect of the present invention, further comprising outputting an audio commentary in response to the outputting of the trigger signal.

According to a seventh aspect of the present invention there is provided a method of providing an educational aid comprising the second aspect of the present invention.

According to a eighth aspect of the present invention there is provided a method of providing an educational aid comprising the second aspect of the present invention.

According to a ninth aspect of the present invention there is provided a computer readable medium having stored therein instructions for causing a processing unit to execute the method of any one of the second, fourth, fifth, sixth, seventh or eighth aspects of the present invention.

According to a tenth aspect of the present invention there is provided a computer readable medium encoding a programme of instructions which when run upon a processor cause the processor to act as the detection means of the first aspect of the present invention.

The invention will now be described, by way of example only, with reference to the accompanying drawings, in which:

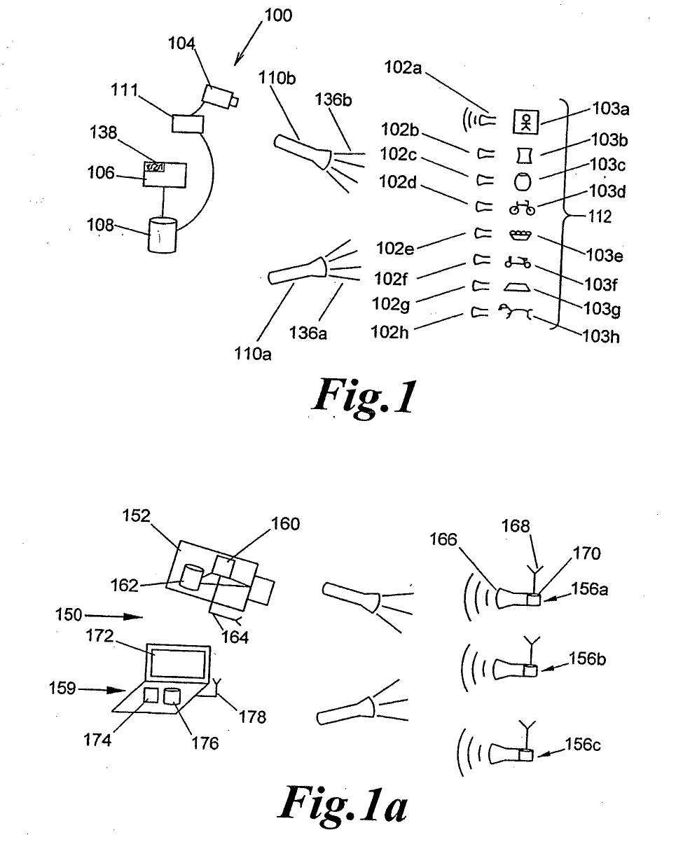

FIG. 1 is a schematic diagram of an optically controlled interactive apparatus according to at least one embodiment of the present invention;

FIG. 1a is a schematic diagram of an optically controlled interactive apparatus according to at least one other embodiment of the present invention;

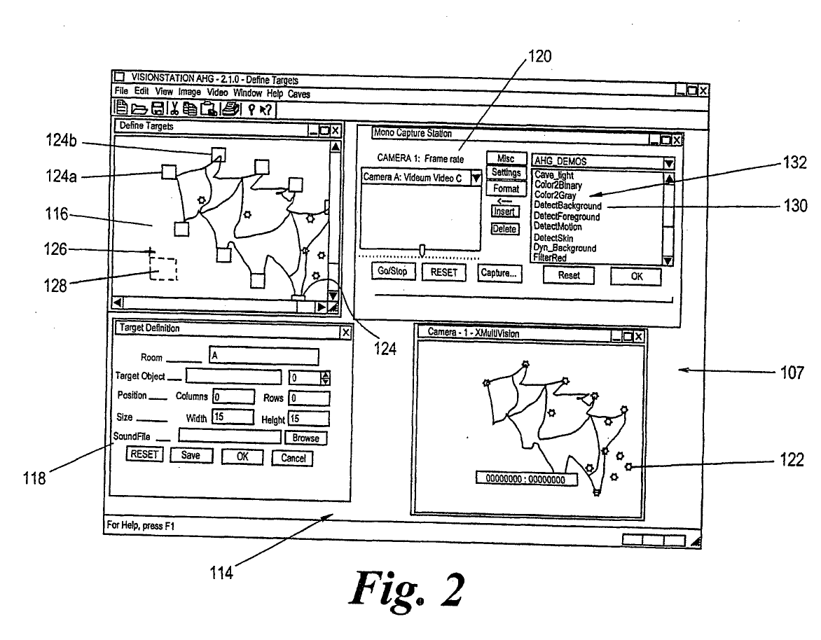

FIG. 2 is a representation of a target selection GUI of the apparatus of FIGS. 1 and 1a;

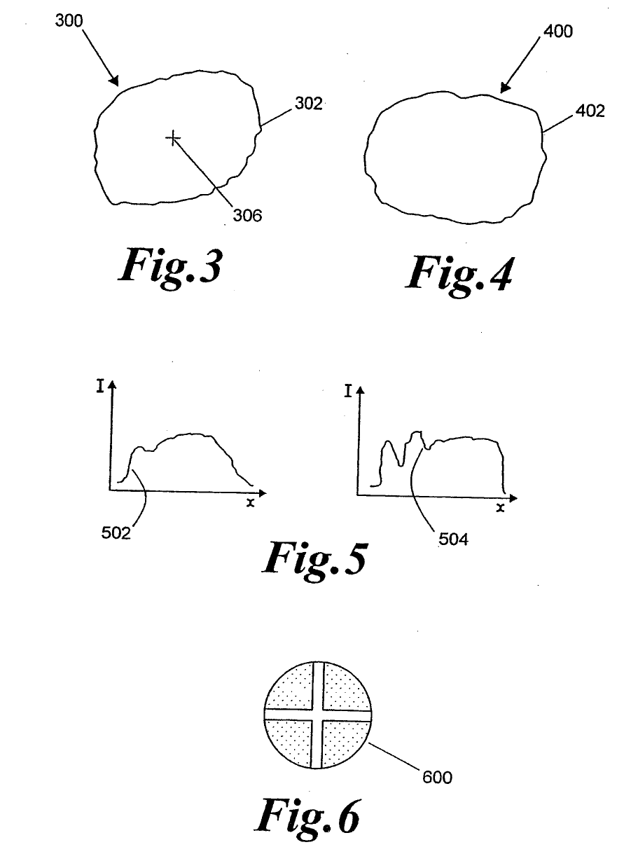

FIG. 3 is a schematic representation of a centroid based beam location scheme;

FIG. 4 is a schematic representation of an overlap based beam location scheme;

FIG. 5 is representation of intensity profiles, of torches, used for characterisation in an embodiment of the present invention;

FIG. 6 is a representation of a an intensity profile varying mask; and

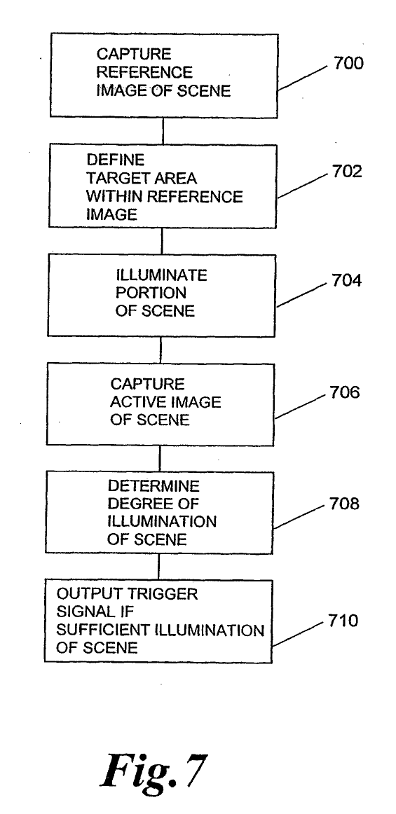

FIG. 7 is a flow diagram showing a method of triggering an optically controlled interactive apparatus according to at least one embodiment of the present invention.

Referring now to FIGS. 1 and 2, an optically interactive apparatus (100), in this example for controlling audio outputs (102a-h) linked to exhibits (103a-h), comprising a video camera (104), a processor (106), a graphical user interface (GUI) (107), a data store (108) and battery operated torches (110a,b).

Video camera (104) captures a reference image (111) of a scene (112) in the absence of illumination from the torches (110a,b). This reference image is passed to the data store (108), a memory, from where it can be called by the processor (106). A routine that generates the GUI (107) runs upon the processor (106) such that the GUI (107) is output to a screen (114).

The GUI (107) typically comprises a define target window (116), a target definition parameter window (118), an output file selection window (120), and an active view window (122). An operator of the apparatus (100) can select target areas (124a-h) using the define target window (116) in which a pair of cross-hairs (126) are used to draw a box (128) about a proposed target area using a mouse (not shown). The target areas (124a-h) are confirmed either by clicking a mouse button or by a pre-defined keystroke on a keyboard (not shown). Alternatively, target areas (124a-h) can be selected by manually entering the position, location, width and height of the proposed target area in the target definition parameter window (118) from a keyboard. Such a “point and click” target selection arrangment is far more efficient than requiring the relocation of physical sensors upon a display by a person as there is no need for the person to, for example, climb ladders in order to remove sensors from their existing positions and place them in their new locations. Additionally, some valuable, delicate and oddly shapes and textured surfaces cannot have sensors put on them.

This arrangement also allows the remote selection of targets, for example, targets could be selected for displays throughout a museum by a single curator in an office using this system, without the curator having to leave the office. The selection of target areas could be made from anywhere in the world over the Internet, which could be useful for teachers to define targets and content in advance of a school visit to a museum or even online players in a game to define targets and messages for their real-world counterparts.

It will be appreciated that the observed scene may or may not be present upon the screen (114) during target selection. The screen may display a data file that may be projected on to a surface. It is also envisaged that people could also email on files and images for targets.

Selection of the target areas (124a-h) can be effected manually by an operator or automatically by the processor running pattern recognition software, or by a combination of the two. For example, gross target area selection is carried out automatically and is manually fine tuned.

Following selection of a target area (124b), an output file (130) is associated with the target area (124b). The output file (130) is either selected from a list (132) displayed within the output file selection window (120) of the GUI (107) or can be selected by manually entering a filename into a data entry box in the target definition parameter window (118) from a keyboard.

The video camera (104) periodically acquires an active image (134) of the scene that is displayed in the active view window (122), typically every 40 ms.

The torches (110a,b), typically employing broad band emission, usually the visible spectrum and any safe or economically viable parts of the invisible spectrum, for example infra-red or ultraviolet, and broad beam width, usually varying form 1 cm to 10 cm in width, sources, such as tungsten filament, or halogen, bulbs with reflectors and lenses are switched on and their beams (136a,b) are moved across the scene. Each torch (110a,b) has a highly individual intensity profile with position within an illuminated area which enables it to be identified and distinguished from the beam of other torches (110b,a), and to be tracked across the scene as will be described hereinafter. Sets of particular features within an intensity or chromatic profile of a torch are referred to as feature vectors, selection of one or more of these feature vectors allows the identification of a particular torch from it's beam and specific feature vectors can be used to track beams across a scene.

As the torch beams (136a,b) enter one of the target areas (124a-h) their presence is noted by the processor which typically applies one of two criteria to determine whether or not to trigger the output file (130) associated with that specific target area (124b). Different target areas can have different output files associated with them. In the case of an output file with an audio component the audio component of the file may be output via open speakers, directional speakers, headphones (wired or wireless) or a hand held speaker device. In the case of an output file with a video component the video component of the file may be output via a projector, a screen or a hand held device, such as for example a personal digital assistant, other possible forms out output that are commonly used in museums include smell and animatronic models. In deed, anything that responds to a control signal, for example—sliding doors, locks etc.

The shape and area, for example the length and ratio of the principal axes of the ellipsoid shape, of the torch beams (136a,b) yield information relating to the distance and orientation of the torch from the scene, surface. The criteria used to identify a flashlight is described hereinafter.

If a large enough target area is selected the motion of the torch beam (136a,b) can be tracked, it's past motion history stored and pattern recognition used to identify characters, such as an alphabetic letter, a symbol or other predetermined shape. Only certain recognised characters may be used to trigger an output file.

One method of locating a torch beam within a scene is to subtract the reference image from the active image to leave a difference image. The positions of the torch beams within the scene will be evident from this difference image as compared to the reference image.

Trigger criteria are now described with reference to FIGS. 3 and 4. One method is to use a beam centroid location scheme for a torch beam (300). This involves an outer locus (302), or periphery, being determined for the beam (300), typically where the intensity of the beam (300) falls below a threshold value, or the contrast between adjacent regions of the beam is above a threshold value, and a geometric centroid (306) of the beam (300) to be calculated by the processor (106). The location of this calculated geometric centroid (306) is then taken to be the location of the beam (300). Thus, when the processor (106) detects the centroid (306) entering the target area (124b) within the active image (134) it triggers the output file (130) associated with the target area (124b).

A second, and in many instances preferred method is to use a beam overlap location scheme for a torch beam (400). This involves the determination of an outer locus (402), or periphery, of the beam (400). This typically involves determining where the intensity of the beam (400) falls below a threshold level, or where the contrast between adjacent regions of the observed beam area have a contrast greater than a threshold value. When the processor (106) detects the outer locus (402) crossing the boundary of the target area (124b) a routine is run that calculates how much of the beam (400) overlaps the target area (124b). This routine is run upon the processor (106) as long as the beam (400) is detected within the target area (124b). The output file (130) will only be triggered when a threshold amount, for example 50%, of the area contained within the outer locus (402) is detected within the target area (124b).

Alternatively, instead of, or in addition to evaluating how much of the beam area is within the target area, an evaluation may be made of how much of the target area is overlapped by beam area. The threshold level of the beam profile may be set such that it is necessary to have two or more beams at least partially overlapping in order to trigger certain responses. This encourages co-operation between and may be particularly useful in, for example, an educational or gaming application for children that encourages social interaction between participants.

Due to the sizeable finite area and shape of the torch beams (136a,b) each beam (136a,b) can sweep out an area and can trigger multiple target areas (124a-h) simultaneously. This is not possible with a laser pointer due to the small cross-sectional area of the beam.

It is possible to configure target areas to generate a trigger signal in response to only certain torches profiles, for example, not all targets are necessarily live for every member of a group. It is also possible to link different output files to a target depending upon which torch illuminates the target, for example, a simple explanation of an exhibit can be output for a torch given to younger children, an intermediate explanation can be output for a torch given to older children and a detailed explanation can be output for a torch given to adults.

In one embodiment the torch beams (136a,b) are modulated, typically by the imposition of a signal to the supply voltage, such that the modulation is not visible to the naked eye but can be captured by the video camera (104). Such a modulation signal can be used as an identifier to identify the torch (110a,b) or alternatively, if switched on, for example by an action of a user such operating a switch, can be used in an analogous fashion to a ‘mouse click’ to allow selection of a target area and not allow selection of a target area when switched off. That is to say, a torch itself can be used to select and/or define target areas in the observed scene.

It will be appreciated that multiple video cameras can be positioned around the scene in order to provide a number of viewing angles for the scene. Inputs from the video cameras are fed to the processor (106) and the same target areas (124a-h) defined in reference views of the scene from each video camera. This reduces effect of obscuration of a target area by a user or third party as the target area resulting in failure to generate a trigger signal as the target area will remain visible from another video camera which can trigger the output file upon the torch beam illuminating the target area.

In a preferred embodiment the processor (106) maintains a history, for example a counter (138) for each torch beam (136a,b), identified either by their intensity or chromatic profiles. Such an identification can be used to distinguish trigger torches from other light sources such as reflections of the sun from a reflective surface.

The use of the intensity profiles of torch beams (136a,b) to identify torches (110a,b) is detailed with reference to FIGS. 5 and 6. A cross-section of intensity profiles (502,504) of two torches (110a,b) show marked differences. These profile differences can be due to manufacturing tolerances in the production of parabolic reflector mirrors, lens pieces and bulbs that make up the light emitting portion of a torch. The profile differences enable the processor (106) to distinguish between different torches and can be used as to identify specific torches even after torch beams have crossed and demerged. This is not readily achieved with laser pointers as there is not sufficient structure in the beam profile to identify individual pointers easily.

Intensity profile differences can be enhanced by the use of a patterned mask (600) for placement over an output, such as a lens, of the torch. The mask (600) can be a simple cut-away mask to provide abrupt changes in intensity profile. Alternatively, the mask (600) be formed of regions of neutral density filter of varying thickness to provide either gradual alteration of the intensity profile or abrupt changes in the intensity profile.

The counter (138) is used to monitor each time a given target area (124a-h) is triggered. This allows the collection of user data for analysis purposes such as, for example, determining the optimum location of target areas within a scene, and user demographic preferences for areas searched for target areas. The use of the counter (138) also allows different output files to be output depending upon how many times a user's torch beam (136a,b) has triggered a given target area. This results in increased user interest in a display and provides the opportunity for layered information dissemination, for example, different chapters of a story to be displayed each time a given torch beam (136a,b) triggers a given target area (124b), or more details being given at successive visits to the same target by a user.

It is also envisaged that the video camera (104) and processor (106) can be used to track shadows cast by the torch beams (136a,b).

Referring now to FIG. 1a, a second embodiment of an optically triggered interactive apparatus (150) comprises a video camera (152), output devices (156a-c), a control unit (159) and battery operated torches (158a,b). The camera (152) contains an integral processor (160), data store (162) and a wireless transceiver (164). The output devices (156a-c) comprise, in this example, an audio output (166), a wireless transceiver (168) and data store (170). The control unit (159), typically a laptop computer or a PC, comprises a screen (172), a processor (174), a data store (176) and a wireless transceiver (178).

In a set up configuration the control unit (159) is connected to the video camera (152) either via their respective wireless transceivers (178,164), typically IEE802.11, Bluetooth or Firewire link, or via a hardwired link, for example via a Universal Serial Bus (USB) cable. Target areas are defined on via a GUI displayed on the screen (172) of the control unit (159), as described hereinbefore with reference to the first embodiment of the invention.

Data corresponding to the target areas and their associated output files are transmitted via the connection between the camera (152) and the control unit (159) to the processor (160) and data store (162) of the camera (152).

The connection between the camera (152) and the control unit (159) can now be broken and the camera (152) assumes control of the triggering operation for the output devices (156a-c) using the integral processor (160) and data store (162). The triggering of the output devices (156a-c) is typically effected using one of two criteria to determine whether or not to trigger the output file (130) associated with that specific target area (124b). The trigger criteria have been described hereinbefore.

The camera (152) usually triggers an output device (156a-c) by sending a trigger signal to the output device via their respective wireless transceivers (164, 168) and an output data file associated with the trigger signal sent is called from the output device's data store (166). Alternatively, an output data file can be recalled from the camera's data store (162) and transmitted to the output device via their respective wireless transceivers (164,168).

It will be appreciated that variations described in relation to the first embodiment of the present invention, for example multiple camera positions and the use of a counter, are equally applicable to the second embodiment of the present invention.

Referring now to FIG. 7, a method of optically triggering an interactive apparatus comprises capturing a reference image of a scene (Step 700), defining at least one target area within the reference image of the scene (Step 702), illuminating a portion of a scene with a torch (Step 704), capturing an active image of the scene (Step 706) determining whether the torch illuminates a least a part of a target area (Step 708) and outputting a trigger signal if the torch illuminates at east a part of the target area in a predetermined manner (Step 710).

Although described with reference to the output of audio data files it will be described that the present invention is equally applicable to the outputting of visual, video and audio-visual data files and also animatronics, smells etc as noted hereinbefore. Indeed it is envisaged that the present invention may be employed in, for example, audio tours of museums, castles, churches, stately home, caves, mines, dungeons, quarries or cellars, interactive posters (e.g. at tradeshows, exhibitions and conferences), interactive rides (e.g. in themeparks), interactive children's toys, interactive signposts and advertising thereupon, interaction in lecture theatres and auditoria, for example to allow voting and selection, interactive wall displays (e.g. in a classroom) and Do-It-Yourself (DIY) applications, for example identifying the location of pipes and/or wires behind plaster to prevent drilling into the pipes and/or wires.

A security system that monitors the progress of security guards and restricts access to designated areas based upon identifying torches used by security staff by their intensity or chromatic profiles is envisaged. Such a system could also be used to identify intruders using torches by their use of a non-known intensity profile.

The use of video tracking of a torch, as described hereinbefore, has a number of advantages over the prior art arrangements including that where a visible torch are used both the user and others nearby can see where the torch are pointing. The torch provides illumination for targets in low lighting environments, for example caves, or where strong light can cause degradation of an exhibit such as an ancient painting or tapestry. Such a system allows users to interact with exhibits at a distance, for example when standing behind a protective barrier.

Additionally, such a system does not require target areas to be visible, i.e. the targets can be hidden, unlike some prior art systems, as they are regions defined in a computer program and allows monitoring of the whole of a scene, surface, of interest. The monitoring of the whole of the surface is useful as it allows statistics to be acquired relating to the areas where a user expects to find a target area and allows a controller to alter the position of targets accordingly, should they wish to do so. The monitoring of the whole area of the surface allows a signal to be output in response to how close a user's torch beam is to a target area, for example an audible sound may increase in volume as a beam moves closer to a target and may decrease in volume the further away from a target the beam moves.

It will be appreciated that although described in relation to torches (flashlights) the present invention can be applied to any video tracked broad beam light source for example a car headlight or a searchlight on a face of a building.

It will further be appreciated that the scene and the target areas may form part of a video image that changes with time. The target areas may therefore not be static within the scene viewed by the video camera but may move within the scene.

1. An optically triggered interactive apparatus, comprising a scene capturer arranged to capture an image of a scene, a target selector arranged to select a target area within a reference image of the scene, a detector arranged to detect the presence of light incident within the target area of an active video image captured by the scene capturer, the detector being arranged to determine an outer extent of an illuminated area, illuminated by a light source, within the scene, and the detector being arranged to output a trigger signal to a processor when a given proportion of the target area forms part of the illuminated area and/or when a given proportion of the illuminated area lies within the target area.

2. (canceled)

3. (canceled)

4. (canceled)

5. (canceled)

6. Apparatus according to claim 1 wherein the detector is arranged to track movement of at least one beam of light incident upon the scene.

7. Apparatus according to claim 1 wherein the detector is arranged to monitor either, or both, of an intensity profile and/or a chromatic profile of a light source, incident upon the scene.

8. Apparatus according to claim 1 wherein the detector is arranged to track a given light source, incident upon the scene based upon whether, one, or both, of the intensity profile and/or the chromatic profile of the light source incident upon the scene.

9. Apparatus according to claim 1 wherein the light source is arranged to be modulated.

10. (canceled)

11. Apparatus according to claim 1 wherein the detector is arranged to increment a counter each time a given light source passes over a given target area.

12. Apparatus according to claim 11 wherein the detector is arranged to output a trigger signal that is dependent upon the value of the counter.

13. (canceled)

14. (canceled)

15. Apparatus according to claim 1 wherein the trigger signal is transmitted wirelessly over a local area network (WLAN) to the actuator.

16. (canceled)

17. Apparatus according to claim 1 comprising a plurality of image capturers, each of which are arranged to capture an active image of the scene from different angles.

18. Apparatus according to claim 17 wherein the detector is arranged to receive inputs from each of the image capturers.

19. Apparatus according to claim 18 wherein the detector is arranged to output a trigger signal to the actuator if one or more target areas is illuminated in at least one of the active images.

20. Apparatus according to claim 1 wherein the scene is a virtual scene and the reference image is a map of the virtual scene.

21. A method of optically triggering an interactive apparatus comprising the steps of:
defining at least one target area within a reference image of a scene;
illuminating a portion of the scene with a light source;
capturing an active image of the scene;
determining a boundary of an area of illumination of the light source;
determining whether a predetermined fraction of the area of illumination illuminates at least part of a target area; and
outputting a trigger signal if the light source illuminates at least a part of the target area in a predetermined manner.

22. (canceled)

23. (canceled)

24. The method of claim 21 including identifying a light source illuminating an area of the scene by means of either an intensity profile or a chromatic profile.

25. (canceled)

26. (canceled)

27. (canceled)

28. (canceled)

29. (canceled)

30. (canceled)

31. (canceled)

32. A user interface located at a user device for use in selecting a target area and a corresponding output file for an optically activated interactive apparatus comprising:
a first input mechanism for selecting an area of an image displayed upon a screen of the device as a target area;
a second input mechanism for selecting the output file corresponding to the selected target area and/or another aspect of the image, the target area and output file having a link generated therebetween; and
an output mechanism arranged to output the output file upon a trigger condition being fulfilled.

33. A user interface according to claim 32 wherein the trigger condition is an image capturer capturing an image of the target area being at least partially illuminated by a broad beam light source.

34. A method of determining user demographic statistics, using an optically triggered interactive apparatus, comprising a scene capturer arranged to capture an image of a scene, a target selector arranged to select a target area within a reference image of the scene, a detector arranged to detect the presence of light incident within the target area of an active video image captured by the scene capturer, the detector being arranged to determine an outer extent of an illuminated area, illuminated by a light source, within the scene, and the detector being arranged to output a trigger signal to a processor when a given proportion of the target area forms part of the illuminated area and/or when a given proportion of the illuminated area lies within the target area, the method comprising the steps of:
providing each user with an identifiable light source;
recording demographic information about each user;
recording each time a target area is triggered by a user; and
identifying each user by correlating their identifiable light source with their demographic information.

35. The method according to claim 34 including recording how long each target area is illuminated by a user's light source.

36. (canceled)

37. A method of defining a target area, for use with an apparatus in accordance with an optically triggered interactive apparatus, comprising a scene capturer arranged to capture an image of a scene, a target selector arranged to select a target area within a reference image of the scene, a detector arranged to detect the presence of light incident within the target area of an active video image captured by the scene capturer, the detector being arranged to determine an outer extent of an illuminated area, illuminated by a light source, within the scene, and the detector being arranged to output a trigger signal to a processor when a given proportion of the target area forms part of the illuminated area and/or when a given proportion of the illuminated area lies within the target area, within a scene comprising:
displaying a reference image upon a screen;
selecting an area of a screen as a target area; and
confirming the selection of the target area.

38. The method of claim 37 including a user manipulated device such as a keyboard, mouse, trackball, or touchscreen to select the target area from the screen.

39. A computer readable medium having stored therein instructions for causing a processing unit to execute a method of optically triggering an interactive apparatus comprising the steps of:
defining at least one target area within a reference image of a scene;
illuminating a portion of the scene with a light source;
capturing an active image of the scene;
determining a boundary of an area of illumination of the light source;
determining whether a predetermined fraction of the area of illumination illuminates at least part of a target area; and
outputting a trigger signal if the light source illuminates at least a part of the target area in a predetermined manner.

40. (canceled)
